(19) United States
(12) Patent Application Publication
(10) Pub. No.: US 2026/0343404 A1
(43) Pub. Date: Oct. 29, 2026

(54) METHOD FOR SWITCHING POWER MODES AND NETWORK ACCESS DEVICE

(71) Applicant: ASUSTeK COMPUTER INC., Taipei City (TW)

(72) Inventors: Ten-Long Dan, Taipei City (TW); Yun-Lun Tsai, Taipei City (TW)

(73) Assignee: ASUSTeK COMPUTER INC., Taipei City (TW)

(21) Appl. No.: 19/649,149

(22) Filed: Apr. 16, 2026

(30) Foreign Application Priority Data
Apr. 25, 2025 (TW) 114115678

(51) Int. Cl. H04W 52/02; H04W 64/00

(52) U.S. Cl. CPC H04W 52/0206; H04W 64/00

(57) ABSTRACT

Provided are a method for switching power modes and a network access device. The method comprises: whether it is needed to switch to a first power mode is determined; a first geographic location of a first communication terminal is obtained from the first communication terminal currently connected to the network access device to serve as a first reference geographic location in response to determining that it is needed to switch to the first power mode; a first query message carrying the first reference geographic location is sent, and a first response message corresponding to the first query message is received; and the first power mode is switched to in response to determining that the first response message indicates that the network access device is allowed to be switched to the first power mode.

### CROSS-REFERENCE TO RELATED APPLICATION

This application claims the priority benefit of Taiwan application serial no. 114115678, filed on Apr. 25, 2025. The entirety of the foregoing patent application is hereby incorporated by reference herein and made a part of this specification.

### BACKGROUND

### Technical Field

The disclosure relates to a mechanism for switching modes, and particularly relates to a method for switching power modes and a network access device.

### Related Art

With the development of wireless communication technology, Wi-Fi has become an indispensable technology in modern network environments, and continues to expand to higher frequency bands to meet growing bandwidth demands. The 6 GHz frequency band (5.925 GHz to 7.125 GHz) is widely recognized as an important frequency band for enhancing Wi-Fi performance due to higher bandwidth capacity and lower interference risk. However, there are many existing protected systems within this frequency band, such as fixed microwave communication links, satellite communications, and other regulated radio equipment. Therefore, to ensure that the use of Wi-Fi devices in the 6 GHz frequency band does not generate harmful interference to the existing systems, regulatory authorities in various countries have established specific specifications for the use of this frequency band.

In the United States, based on the specifications of the Federal Communications Commission (FCC), the Wi-Fi Alliance mandates the utilization of Automatic Frequency Coordination (AFC) system in the 6 GHz frequency band to manage the frequency band usage and power configuration of related network access devices (such as Wi-Fi access point (AP) devices). The AFC system maintains frequency band usage information of the existing systems through a central database. When an AP applies to use the 6 GHz frequency band, the AFC system determines whether the frequency band usage might affect existing systems based on a geographic location of the AP, and decides whether the AP operates in a standard power mode. Only when the AFC confirms that the operation of the AP does not cause interference to the existing systems, may the AP operate in the standard power mode.

Therefore, to ensure that the specifications of the AFC system are met, APs with AFC functions must be able to determine their own geographic location to provide a basis for the AFC system to authorize frequency band usage.

Traditionally, Wi-Fi access point devices usually have a built-in positioning circuit to ensure the accuracy of location information. For example, an AP may be equipped with a global positioning system (GPS) chip to obtain a latitude and a longitude of the device, and might comprises a barometer to determine an altitude of the device, thereby more accurately determining whether the AP meets the operating conditions for the standard power mode.

However, for Wi-Fi access point devices without any built-in positioning circuit, they might be unable to switch to operate in the standard power mode because the basis for the AFC system to authorize frequency band usage is unable to be provided.

### SUMMARY

In view of this, the disclosure provides a method for switching power modes and a network access device, which can be configured to solve the foregoing technical problem.

The embodiment of the disclosure provides a method for switching power modes executed by a network access device, which comprises: whether it is needed to switch to a first power mode is determined; obtaining a first geographic location of a first communication terminal from the first communication terminal currently connected to the network access device to serve as a first reference geographic location in response to determining that it is needed to switch to the first power mode; a first query message carrying the first reference geographic location is sent, and a first response message corresponding to the first query message is received; and the first power mode is switched to in response to determining that the first response message indicates that the network access device is allowed to be switched to the first power mode.

The embodiment of the disclosure provides a network access device, which comprises a non-transitory storage circuit and a processor. The non-transitory storage circuit stores code. The processor is coupled to the non-transitory storage circuit and accesses the code to: determine whether it is needed to switch to a first power mode; obtain a first geographic location of a first communication terminal from the first communication terminal currently connected to the network access device to serve as a first reference geographic location in response to determining that it is needed to switch to the first power mode; send a first query message carrying the first reference geographic location, and receive a first response message corresponding to the first query message; and switch to the first power mode in response to determining that the first response message indicates that the network access device is allowed to be switched to the first power mode.

### BRIEF DESCRIPTION OF THE DRAWINGS

FIG. 1 is a schematic diagram of a network access device according to an embodiment of the disclosure.

FIG. 2 is a flow chart of a method for switching power modes according to an embodiment of the disclosure.

FIG. 3 is a flow chart of a method for switching power modes after experiencing a restart procedure according to FIG. 2.

FIG. 4 is a flow chart of a method for switching power modes according to FIG. 2.

### DESCRIPTION OF THE EMBODIMENTS

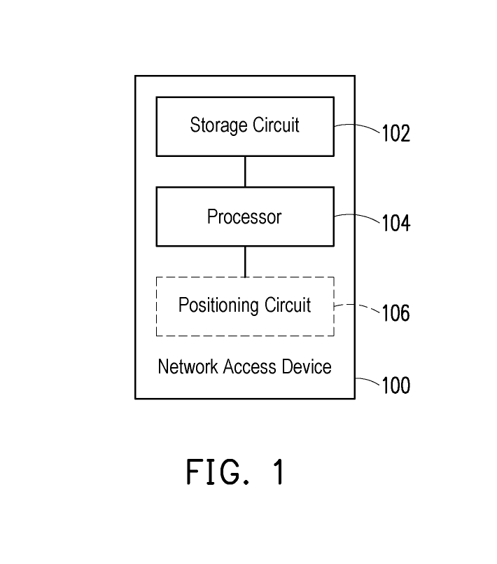

Referring to FIG. 1, which is a schematic diagram of a network access device according to an embodiment of the disclosure. In one embodiment, a network access device 100 is implemented as various network devices that provides network access functions. In one embodiment, the network access device 100 is a wireless access point (AP), wireless router, mobile hotspot (such as standalone mobile hotspot device or smartphone hotspot function), network gateway, cellular base station (such as small base station or home base station), Wi-Fi repeater/bridge or other network devices. In one embodiment, these devices provide internet or local network access functions for connected communication terminals (such as mobile phones, tablets, and various terminal devices) through Wi-Fi, mobile network, or wired network. However, the disclosure is not limited thereto.

In FIG. 1, the network access device 100 comprises a storage circuit 102 and a processor 104.

The storage circuit 102 is any type of fixed or movable random access memory (RAM), read-only memory (ROM), flash memory, hard drive or other similar devices or a combination of these devices, and configures to record multiple code or modules.

The processor 104 is coupled to the storage circuit 102, and is a general purpose processor, special purpose processor, conventional processor, digital signal processor, multiple microprocessors, one or more microprocessors combined with digital signal processor cores, controllers, microcontrollers, application specific integrated circuit (ASIC), field programmable gate array (FPGA), any other type of integrated circuit, state machines, Advanced RISC Machine (ARM) based processors or the like.

In addition, in some embodiments, the network access device 100 further comprises a positioning circuit 106. In one embodiment, the positioning circuit 106 is configured to detect a current location of the network access device 100. In other embodiment, a positioning circuit is implemented utilizing various technologies, such as GNSS circuit, cellular positioning circuit, Wi-Fi positioning circuit (WPS), Bluetooth and ultra-wideband (UWB) positioning circuit, angle of arrival (AoA) or ultra-wideband time of flight (ToF) technology, sensor-assisted positioning circuit, hybrid positioning circuit, etc. However, the disclosure is not limited thereto.

In one embodiment of the disclosure, the network access device 100 operates in a first power mode or a second power mode.

In one embodiment, in the first power mode the network access device 100 uses higher communication power (for example, higher than a first power threshold) to implement related communication functions. On the other hand, in the second power mode is, the network access device 100 uses lower communication power (for example, lower than a second power threshold) to implement related communication functions. In the embodiment, the first power threshold is higher than the second power threshold. Specific values of the two thresholds are determined according to the designer’s needs and/or the geographic region where the network access device 100 is located.

In an embodiment, assuming the network access device 100 is a Wi-Fi access point device that uses the 6 GHz frequency band for communication, the first power mode is the standard power mode previously mentioned, while the second power mode is a non-standard power mode. In this embodiment, the standard power mode typically allows higher communication power. In an embodiment, under the US FCC specification, a maximum equivalent isotropic radiated power (EIRP) reaches 36 dBm (4 watts), with a maximum transmission power of 30 dBm (1 watt), but needs to ensure through an automated frequency control (AFC) system that the frequency band usage does not interfere with existing systems. In comparison, the non-standard power mode has lower power limitations, with a maximum EIRP of 30 dBm (1 watt) and a maximum transmission power of 24 dBm (0.25 watt), and does not need AFC restrictions, but is typically limited to indoor use.

In one embodiment of the disclosure, the processor 104 accesses modules and code recorded in the storage circuit 102 to implement the method for switching power modes proposed by the disclosure.

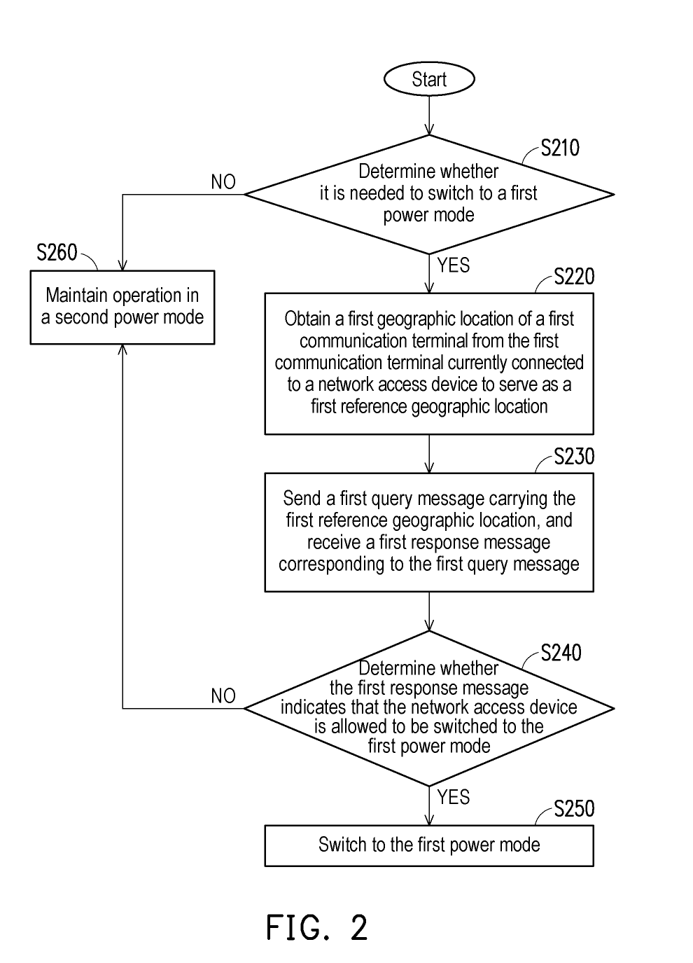

Please refer to FIG. 2, which is a flow chart of a method for switching power modes according to an embodiment of the disclosure. The method of the embodiment is executed by the network access device 100 of FIG. 1. The details of each step in FIG. 2 will be described below in conjunction with the elements shown in FIG. 1.

In step S210, the processor 104 determines whether it is needed to switch to the first power mode.

In detail, in one embodiment, when the network access device 100 is configured to provide network access functions to communication terminals (such as mobile phones) connected thereto, the user sets/configures an operation manner and/or an operation parameter of the network access device 100 through operating a specific application on the communication terminal.

In one embodiment, the user sets whether to enable the first power mode for the network access device 100 through the foregoing application. When the first power mode has been enabled, the network access device 100 attempts to switch to the first power mode under specific conditions.

In one embodiment, for the network access device 100 that experiences a restart procedure, the network access device 100 is preset to operate in the second power mode. In this condition, when the network access device 100 is configured/set to have enabled the first power mode, the processor 104 performs related procedures to attempt to switch to the first power mode.

In other embodiments, the network access device 100 also is preset to have enabled the first power mode. However, the disclosure is not limited thereto.

Based on this, during a process of executing step S210, the processor 104 determines whether the network access device 100 is configured to have enabled the first power mode.

In one embodiment, in response to determining that the network access device 100 is configured to have enabled the first power mode, the processor 104 determines that it is needed to switch to the first power mode, and subsequently executes step S220. On the other hand, in response to determining that the network access device 100 is not configured to have enabled the first power mode, the processor 104 determines that it is not needed to switch to the first power mode, and subsequently executes step S260 to maintain operation in the second power mode.

In step S220, the processor 104 obtains a first geographic location of a first communication terminal from the first communication terminal currently connected to the network access device 100 to serve as a first reference geographic location.

In different embodiments, the first communication terminal is various terminal devices currently connected to the network access device 100 to use the network access function provided. In addition, the first geographic location of the first communication terminal is provided by a built-in positioning circuit (such as the GPS chip previously mentioned) of the first communication terminal, and is configured to characterize a current terminal location of the first communication terminal. However, the disclosure is not limited thereto.

In one embodiment, before the first geographic location of the first communication terminal is obtained from the first communication terminal, the processor 104 first provides a push message to the first communication terminal. The push message is configured to query whether the first communication terminal agrees to provide the first geographic location.

In one embodiment, the foregoing push message is displayed to the user by the specific application previously mentioned, and provides related options that characterize whether to agree to provide the first geographic location to the network access device 100 for the user to confirm. Afterwards, the first communication terminal generates a corresponding confirmation message according to an option selected by the user, and send the confirmation message to the network access device 100.

In another embodiment, the first communication terminal is preset to agree to provide the first geographic location, and directly returns a confirmation message in response to the foregoing query message. However, the disclosure is not limited thereto.

Correspondingly, the processor 104 receives the confirmation message corresponding to the push message from the first communication terminal, and determine whether the confirmation message indicates that the first communication terminal (or the user) agrees to provide the first geographic location.

In one embodiment, in response to determining that the confirmation message indicates the first communication terminal agrees to provide the first geographic location, the processor 104 receives the first geographic location from the first communication terminal, and takes the first geographic location to serve as the first reference geographic location. In one embodiment, when the first geographic location has been directly carried in the confirmation message, the processor 104 determines that the confirmation message has indicated that the first communication terminal agrees to provide the first geographic location, and directly read the first geographic location from the confirmation message to serve as the first reference geographic location. However, the disclosure is not limited thereto.

On the other hand, in response to determining that the confirmation message indicates the first communication terminal does not agree to provide the first geographic location, the processor 104 maintains operation in the second power mode (for example, directly execute step S260). However, the disclosure is not limited thereto.

In step S230, the processor 104 sends a first query message carrying the first reference geographic location, and receives a first response message corresponding to the first query message.

In one embodiment, the processor 104 sends the first query message to the AFC system previously mentioned to trigger the AFC system to determine whether the first reference geographic location is located within a preset geographic region where a use of the first power mode is allowed.

In one embodiment, the AFC system records one or more preset geographic regions where a use of the first power mode is allowed. For network access devices located within the one or more preset geographic regions, the AFC system determines that the network access devices do not affect existing systems even when using the first power mode. On the other hand, for network access devices not located within the one or more preset geographic regions, the AFC system determines that the network access devices are not allowed to use the first power mode.

Based on this, after the AFC system receives the first query message, a corresponding first response message is generated according to a determination result of whether the first reference geographic location is located within the preset geographic region where a use of the first power mode is allowed, and return the first response message to the network access device 100.

In one embodiment, if the AFC system determines that the first reference geographic location is located within the preset geographic region, it is indicated in the first response message that the network access device 100 is allowed to be switched to the first power mode. On the other hand, if the AFC system determines that the first reference geographic location is not located within the preset geographic region, it is indicated in the first response message that the network access device 100 is not allowed to be switched to the first power mode. However, the disclosure is not limited thereto.

Correspondingly, the processor 104 receives the first response message corresponding to the first query message from the AFC system, and subsequently executes step S240.

In step S240, the processor 104 determines whether the first response message indicates that the network access device 100 is allowed to be switched to the first power mode.

In one embodiment, in response to determining that the first response message indicates that the network access device 100 is allowed to be switched to the first power mode (for example, the first geographic location is located within the preset geographic region), the processor 104 subsequently executes step S250 to switch to the first power mode.

On the other hand, in response to determining that the first response message indicates that the network access device 100 is not allowed to be switched to the first power mode (for example, the first geographic location is not located within the preset geographic region), the processor 104 subsequently executes step S260 to maintain operation in the second power mode.

From the above, it can be seen that the network access device 100 according to the embodiment of the disclosure is, after obtaining the first geographic location of the first communication terminal, take the first geographic location to serve as a basis for querying whether to switch to the first power mode. In this condition, even if the network access device 100 itself is not provided with a positioning circuit, the network access device 100 still smoothly switches to the first power mode (such as the standard power mode) when specific conditions are met (for example, the first geographic location is located within the preset geographic region).

In one embodiment, after executing step S260, the network access device 100 continuously maintains operation in the second power mode until experiencing a restart procedure.

Similarly, after executing step S250, the network access device 100 is continuously maintain operation in the first power mode until experiencing a restart procedure.

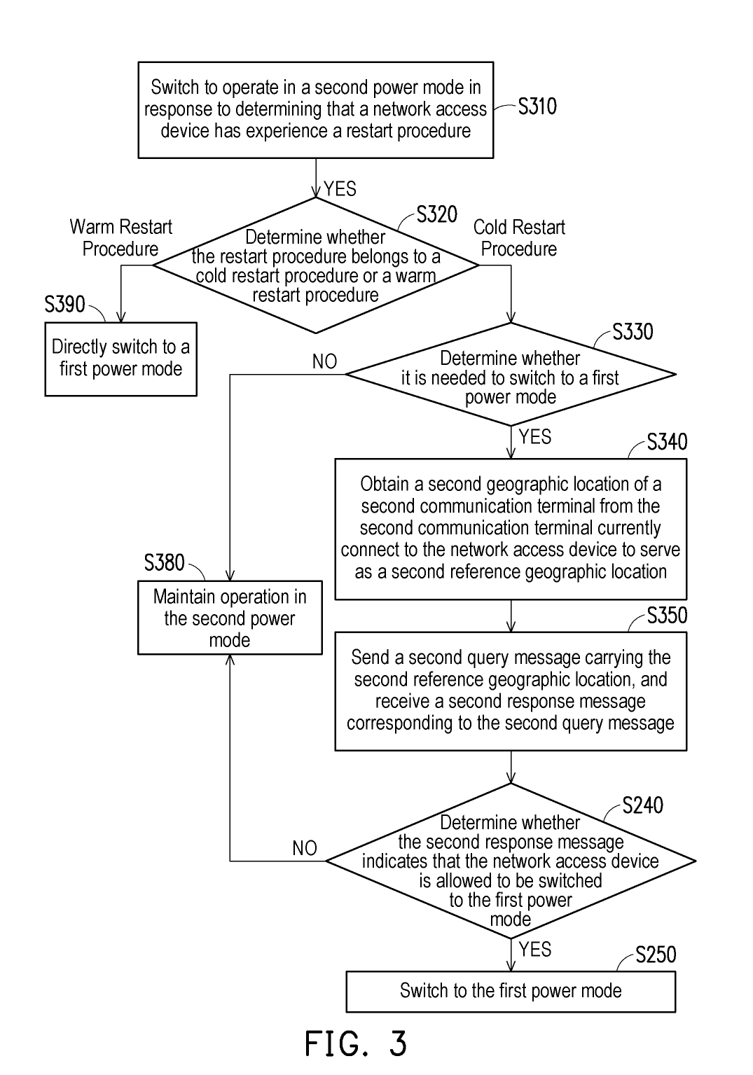

Please refer to FIG. 3, which is a flow chart of a method for switching power modes after experiencing a restart procedure according to FIG. 2.

In step S310, in response to determining that the network access device 100 has experienced a restart procedure, the processor 104 switches the network access device 100 to operate in the second power mode.

In step S320, the processor 104 determines whether the foregoing restart procedure belongs to a cold restart procedure or a warm restart procedure.

In the embodiment of the disclosure, a cold restart procedure refers to a process of restarting the system after the computer is completely powered off. Specifically, this means that before executing the restart, the power supply is thoroughly cut off, such as turning off the power switch, unplugging the power cord, or removing the battery in a laptop. When the power is reconnected and the power button is pressed, the system executes the startup process from scratch. At this time, BIOS or UEFI starts and runs the power-on self-test (POST), checking whether components such as the processor, memory, storage device are operating normally. Subsequently, the operating system may reload from the boot device into the memory. The characteristic of a cold restart is that it completely clears all temporary data and states in the system, and both hardware and software return to an initial state.

On the other hand, a warm restart procedure refers to restarting the system through software or hardware commands in a condition where the computer remains powered on. This manner does not need to turn off the power supply, but directly triggers a system reset, such as selecting "Restart" in the operating system, using Ctrl+Alt+Delete keys, or pressing the reset button on the machine body. During a warm restart process, the power supply continues to operate, hardware components do not completely lose power, and some data in memory may be preserved before restarting. BIOS or UEFI reloads the operating system, but since the hardware is already in an operational state, the POST detection process is simplified compared to a cold restart procedure.

Generally, a warm restart procedure needs less time (such as within 3 minutes), and the location of the network access device 100 and/or the first communication terminal is less likely to change significantly in such a short period of time. Based on this, in response to determining that the restart procedure belongs to a warm restart procedure, the processor 104 subsequently executes step S390 to directly switch the network access device 100 to operate in the first power mode.

In another embodiment, in response to determining that the restart procedure belongs to a cold restart procedure, this indicates that the location of the network access device 100 and/or the first communication terminal may have undergone a more significant change, so it might be unable to directly use the first power mode. Based on this, the processor 104 subsequently executes step S330 and subsequent steps thereof.

In step S330, the processor 104 determines whether it is needed to switch to the first power mode.

In one embodiment, in response to determining that it is needed to switch to the first power mode, the processor 104 subsequently executes step S340. On the other hand, in response to determining that it is not needed to switch to the first power mode, the processor 104 subsequently executes step S380.

In step S340, the processor 104 obtains a second geographic location of a second communication terminal currently connected to the network access device 100 to serve as a second reference geographic location.

In step S350, the processor 104 sends a second query message carrying the second reference geographic location, and receives a second response message corresponding to the second query message.

In step S360, the processor 104 determines whether the second response message indicates that the network access device 100 is allowed to be switched to the first power mode. In one embodiment, in response to determining that the second response message indicates that the network access device 100 is allowed to be switched to the first power mode, the processor 104 subsequently executes step S340. On the other hand, in response to determining that the second response message indicates that the network access device 100 is not allowed to be switched to the first power mode, the processor 104 subsequently executes step S380.

In step S370, the processor 104 switches the network access device 100 to the first power mode.

In step S380, the processor 104 maintains the network access device 100 to operate in the second power mode.

In FIG. 3, the details of steps S330 to S380 reference the related descriptions of steps S210 to S260 in FIG. 2, which will not be repeated here.

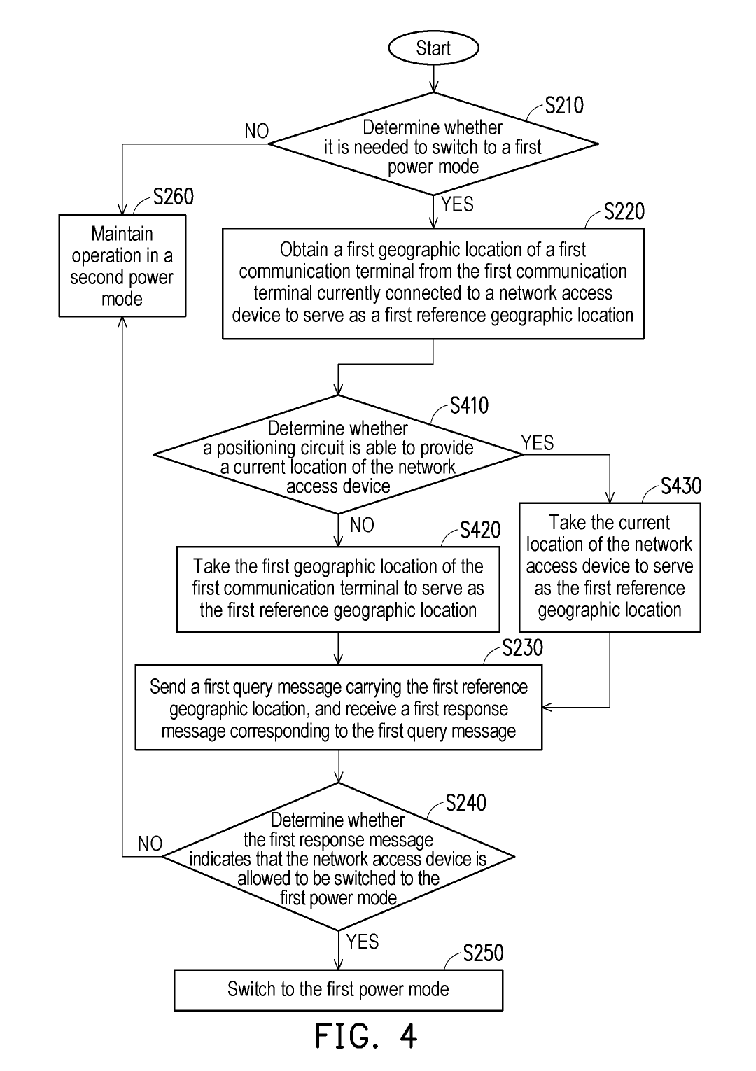

In one embodiment, for the network access device 100 provided with the positioning circuit 106, the flow chart of FIG. 2 is modified to the aspect of FIG. 4.

Please refer to FIG. 4, which is a flow chart of a method for switching power modes according to FIG. 2.

In FIG. 4, when the network access device 100 has the positioning circuit 106, the processor 104, after executing step S220, additionally executes step S410 to determine whether the positioning circuit 106 is able to provide a current location of the network access device 100 (such as current GPS coordinates of the network access device 100, or other geographic information that characterizes a location of the network access device 100).

In one embodiment, in response to determining that the positioning circuit 106 is unable to provide the current location of the network access device 100 (for example, the positioning circuit 106 is malfunctioning, GPS signal quality is poor, etc.), the processor 104 correspondingly, in step S420, takes the first geographic location of the first communication terminal to serve as the first reference geographic location, and subsequently executes step S230.

On the other hand, in response to determining that the positioning circuit 106 is able to provide the current location of the network access device 100, the processor 104 correspondingly, in step S430, takes the current location of the network access device 100 to serve as the first reference geographic location, and subsequently executes step S230.

In FIG. 4, the content of steps S210 to S260 references the related descriptions in the previous embodiment, which will not be repeated here.

From the above, it can be seen that for the network access device 100 provided with the positioning circuit 106, the processor 104 is, in some embodiments, prioritize taking the current location provided by the positioning circuit 106 to serve as the first reference geographic location carried in the first query message. In some embodiments, if the positioning circuit 106 is unable to provide the current location of the network access device 100 for some reason (such as malfunction, poor signal quality, etc.), the processor 104 maintains taking the first geographic location detected by the first communication terminal to serve as the first reference geographic location carried in the first query message.

In addition, the concept of steps S410 to S430 in FIG. 4 can be applied to the flow chart in FIG. 3.

In one embodiment, when the network access device 100 under consideration is provided with the positioning circuit 106, the processor 104, after executing step S340 of FIG. 3, does not directly execute step S350, but instead additionally determines whether the positioning circuit 106 is able to provide the current location of the network access device 100. In one embodiment, in response to determining that the positioning circuit 106 is unable to provide the current location of the network access device 100, the processor 104 correspondingly takes the second geographic location of the second communication terminal to serve as the second reference geographic location, and subsequently executes step S350. On the other hand, in response to determining that the positioning circuit 106 is able to provide the current location of the network access device 100, the processor 104 correspondingly takes the current location of the network access device 100 to serve as the second reference geographic location, and subsequently executes step S350.

In summary, after obtaining the first geographic location of the first communication terminal, the method proposed by the embodiment of the disclosure takes the first geographic location to serve as the basis for querying whether to switch to the first power mode. In this condition, even if the network access device itself is not provided with a positioning circuit, the network access device still smoothly switches to the first power mode (such as the standard power mode) when specific conditions are met (for example, the first geographic location is within the preset geographic region).

In addition, for network access devices provided with a positioning circuit, the method proposed by the embodiment of the disclosure also, in certain scenarios (such as when the positioning circuit malfunctions and/or has poor signal quality), takes the first geographic location detected by the first communication terminal to serve as the first reference geographic location carried in the first query message. In this way, the flexibility of the network access device in switching power modes can be improved.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A method for switching power modes, executed by a network access device, comprising:
determining whether it is needed to switch to a first power mode;
obtaining a first geographic location of a first communication terminal from the first communication terminal currently connected to the network access device to serve as a first reference geographic location in response to determining that it is needed to switch to the first power mode;
sending a first query message carrying the first reference geographic location, and receiving a first response message corresponding to the first query message; and
switching to the first power mode in response to determining that the first response message indicates that the network access device is allowed to be switched to the first power mode.

2. The method according to claim 1, wherein the network access device is preset to operate in a second power mode, and the method further comprises:
maintaining operation in the second power mode in response to determining that the first response message indicates that the network access device is not allowed to be switched to the first power mode.

3. The method according to claim 1, wherein sending the first query message carrying the first reference geographic location, and receiving the first response message corresponding to the first query message comprises:
sending the first query message carrying the first reference geographic location to an automatic frequency coordination system, and receiving the first response message corresponding to the first query message from the automatic frequency coordination system.

4. The method according to claim 3, wherein the first query message is configured to trigger the automatic frequency coordination system to determine whether the first reference geographic location is within a preset geographic region where a use of the first power mode is allowed.

5. The method according to claim 1, wherein the network access device is preset to operate in a second power mode, wherein determining whether it is needed to switch to the first power mode comprises:
determining whether the network access device is configured to have enabled the first power mode;
determining that it is needed to switch to the first power mode in response to determining that the network access device is configured to have enabled the first power mode; and
determining that it is not needed to switch to the first power mode, and maintaining operation in the second power mode in response to determining that the network access device is not configured to have enabled the first power mode.

6. The method according to claim 1, wherein the network access device is preset to operate in a second power mode, and before obtaining the first geographic location of the first communication terminal to serve as the first reference geographic location, further comprising:
providing a push message to the first communication terminal, and receiving a confirmation message corresponding to the push message from the first communication terminal, wherein the push message is configured to query whether the first communication terminal agrees to provide the first geographic location;
receiving the first geographic location from the first communication terminal, and taking the first geographic location to serve as the first reference geographic location in response to determining that the confirmation message indicates that the first communication terminal agrees to provide the first geographic location; and
maintaining operation in the second power mode in response to determining that the confirmation message indicates that the first communication terminal does not agree to provide the first geographic location.

7. The method according to claim 1, wherein after switching to the first power mode, the method further comprises:
switching to operate in a second power mode in response to determining that the network access device experiences a restart procedure; and
directly switching to the first power mode in response to determining that the restart procedure is a warm restart procedure.

8. The method according to claim 7, further comprising:
determining whether it is needed to switch to the first power mode in response to determining that the restart procedure is a cold restart procedure;
obtaining a second geographic location of a second communication terminal from the second communication terminal currently connected to the network access device to serve as a second reference geographic location in response to determining that it is needed to switch to the first power mode;
sending a second query message carrying the second reference geographic location, and receiving a second response message corresponding to the second query message; and
switching to the first power mode in response to determining that the second response message indicates that the network access device is allowed to be switched to the first power mode.

9. The method according to claim 1, wherein the network access device is configured with a positioning circuit, and before sending the first query message carrying the first reference geographic location, the method further comprises:
determining whether the positioning circuit is able to provide a current location of the network access device;
taking the current location of the network access device to serve as the first reference geographic location in response to determining that the positioning circuit is able to provide the current location of the network access device; and
taking the first geographic location of the first communication terminal to serve as the first reference geographic location in response to determining that the positioning circuit is unable to provide the current location of the network access device.

10. A network access device, comprising:
a non-transitory storage circuit, storing code; and
a processor, coupled to the non-transitory storage circuit and accessing the code to:
determine whether it is needed to switch to a first power mode;
obtain a first geographic location of a first communication terminal from the first communication terminal currently connected to the network access device to serve as a first reference geographic location in response to determining that it is needed to switch to the first power mode;
send a first query message carrying the first reference geographic location, and receive a first response message corresponding to the first query message; and
switch to the first power mode in response to determining that the first response message indicates that the network access device is allowed to be switched to the first power mode.
